(19) United States
(12) Patent Application Publication
(10) Pub. No.: US 2013/0058824 A1
(43) Pub. Date: Mar. 7, 2013

(54) METHOD FOR PRODUCING DECORATIVE SINTERED METALLIC ARTICLE AND DECORATIVE SINTERED METALLIC ARTICLE

(71) Applicants: Masashi Hirama, Fuchu-shi (JP); Hidekazu Yoshihara, Fuchu-shi (JP); Toshie Ito, Fuchu-shi (JP)

(72) Inventors: Masashi Hirama, Fuchu-shi (JP); Hidekazu Yoshihara, Fuchu-shi (JP); Toshie Ito, Fuchu-shi (JP)

(73) Assignee: AIDA CHEMICAL INDUSTRIES CO., LTD., Fuchu-shi, Tokyo (JP)

(21) Appl. No.: 13/695,692

(22) PCT Filed: Nov. 4, 2010
(86) PCT No.: PCT/JP2010/069562

§ 371 Date: Nov. 1, 2012

(51) Int. Cl. B22F 7/02; B32B 15/01

(52) U.S. Cl. 419/7; 75/228

(57) ABSTRACT

Provided is a method for producing a decorative sintered metallic article and the same, used in jewelry goods, ornaments, clothing accessories, by combining a copper paste and a silver paste. The method comprises the steps of: producing a patterned piece by alternately arranging the copper paste containing an organic binder and water in 10 to 35 wt % and one or more kinds of copper powders selected from a copper powder and a copper alloy powder, and the silver paste similarly prepared to the copper paste; forming patterned pastes by drawing a pattern through deforming at least rows on the upper surface of the alternately arranged copper and silver pastes; drying the patterned pastes to produce a patterned piece; shaping a decorative object by processing the produced patterned piece; and firing the decorative object to produce a decorative sintered object.

### FIELD OF THE INVENTION

The present invention relates to a method for producing a decorative sintered metallic article and the decorative sintered metallic article, used in jewelry goods, ornaments, and clothing accessories or the like; the decorative sintered metallic article being produced by using a copper paste containing at least water and one or more kinds of copper powders selected from a copper powder and a copper alloy powder, and a silver paste containing at least water and one or more kinds of silver powders selected from a silver powder and a silver alloy powder.

### BACKGROUND OF THE INVENTION

Recently, the technique of “Coffee Art”, which consists of the drawing of a picture created only by using coffee poured into a cup and milk has been favored. A temporary pattern created by such a Coffee Art technique, or a so called Coffee Art pattern, looks greatly beautiful.

Conventionally, a technique for producing a decorative sintered metallic article has been well known as joining different kinds of precious metals with different color tones and appearances including, for example, conventional metal-carving techniques such as an inlaid technique and a woodgrain metal technique. However, there has as yet not been established a technique for obtaining a decorative sintered metallic article produced by using different kinds of precious metals with an extremely complicated intertwined pattern like a Coffee Art pattern.

Here, Patent Documents 1-3 disclose methods which propose producing a decorative sintered metallic article by combining metallic sinters with different colors through using a plastic clay compound containing a precious metallic powder.

Herein, Patent Documents 1-3 describe that copper is categorized as a precious metal, while copper has characteristics that corrosion resistance thereof (or oxidation resistance) is markedly inferior to that of general precious metals such as gold, silver and platinum group elements. That is, copper or a copper alloy has characteristics of being oxidized when heated in an oxidation atmosphere (or in the air).

The Patent Document 1 proposes a method comprising the steps of: shaping a first “plastic clay compound containing a precious metallic powder”; forming a plurality of through holes thereto; filling another “plastic clay compound containing a precious metallic powder” with a different color into the through holes; cutting off the resulting object such that each plastic clay compound is disposed respectively; and firing the cuttings. Further, the Patent Document 1 also proposes a method comprising the steps of: forming plate-like “plastic clay compounds containing precious metallic powders” each having a different color; stacking the plurality of the plates; winding up the stack into a roll shape; cutting off the roll shaped object; and firing the cuttings.

The Patent Document 2 describes a method comprising the steps of: forming a first plastic clay compound containing a precious metallic powder in a plate-like shape; removing a part of the plate at a desired region; filling a second plastic clay compound containing a precious metallic powder with a different color into the region from which the part of the plate has been removed; and firing the resulting object.

The Patent Document 3 describes a method comprising the steps of: pre-forming a plurality of precious metal plastic clay compounds with respectively different colors through a firing process, in a block-like shape or a plate-like shape; combining those materials such that front and rear patterns of the combined product are joined; and firing the resultant product.

However, the techniques described in the Patent Documents 1-3 are a method for joining the plastic clay compounds able to be plastically deformed, that is, with roughly combining the compounds in a so called clay-like state. More specifically, when a joined area (or joined portion) is small (or the number thereof is a very few), the product after firing turns to be separated in pieces. Accordingly, this method can be applied to a decorative sintered metallic article only designed to have a large joined area (or a broad joined portion), resulting in a large limitation of the design thereof. Thus, every technique in the Patent Documents 1-3 is absolutely unable to be a technique for forming a Coffee Art pattern in which different kinds of metals with different colors are extremely and complicatedly intertwined.

Further, the Patent Documents 1-3 do not clearly describe the firing conditions, and in particular, the Patent Document 3 discloses no description of the firing atmosphere.

The Patent documents 1 and 2 describe that a plastic clay compound containing a pure gold powder is fired in the air, that is, in the oxidation atmosphere, while a plastic clay compound containing a so called K18 alloy made by mixing gold in 75.0 wt %, silver in 12.5 wt % and copper in 12.5 wt % is fired in the argon atmosphere. In other words, the Patent Documents 1 and 2 disclose that even though the plastic clay compound containing the K18 alloy including copper only in 12.5 wt %, the firing process thereof has to be conducted in the inert atmosphere.

As mentioned above, both Patent Documents 1 and 2 propose a method that plastic clay compounds containing metallic powders with different colors are fired in the physically joined state. However, there is no description on what firing conditions should be used, when a plastic clay compound A containing a pure gold powder to be fired in the oxidation atmosphere and a plastic clay compound B containing copper such as a K18 alloy to be fired in the inert atmosphere are joined together and fired.

Further, according to a reference document issued by the applicant of the Patent Documents 1-3, is described a method for firing a shaped object of a plastic clay compound containing powder of bronze which is a copper alloy including tin. That is, a bronze shaped object is placed on a bed of reduction agent such as charcoal applied on an aluminum foil, and the bronze shaped object is covered by a stainless steel vessel and heated at 860° C. for 1 to 3 hr.

### PRIOR ART DOCUMENTS

### Patent Literatures

[Patent Document 1] Japanese Patent No. 2932648
[Patent Document 2] Japanese Patent No. 2924139
[Patent Document 3] Japanese Patent No. 3389613

### DISCLOSURE OF THE INVENTION

### Problems to be Solved by the Invention

As described hereinbefore, the techniques described in the Patent Documents 1-3 using plastic clay compounds containing precious metallic powders may produce a decorative sintered metallic article made of different metals. However, note the technique is a method for joining materials in a roughly combined manner, thereby to be extremely difficult in forming a fine and flowing pattern and to have a large restriction for designing an object. Therefore, every technique in the Patent Documents 1-3 is absolutely unable to be a method for forming a Coffee Art pattern in which different kinds of metals with different colors are extremely and complicatedly intertwined.

Accordingly, the techniques described in the Patent Documents 1-3 are so difficult in producing a decorative sintered metallic article having a fine and flowing Coffee Art pattern in which different colored precious metals are extremely and complicatedly intertwined. Hereby, the decorative sintered metallic article having such a specific pattern may not be easily produced, for example in a further education school or the like.

Further, as described hereinbefore, it is well known that the firing of a copper plastic clay compound containing at least one kind of a copper powder selected from a copper powder and a copper alloy powder is basically conducted in the inert atmosphere, that is, in the reduction atmosphere. In contrast, assume a composite shaped object, which is formed by joining the plastic copper clay compound to a plastic precious metal clay compound containing a precious metal powder such as a silver powder having an anti-oxidation profile. If such a composite shaped object is fired, it is not known what conditions and procedures should be used specifically for producing a decorative sintered metallic article without damaging the shape by firing the composite shaped object. Note the anti-oxidation profile is a chemical property not being oxidized in the air firing.

From the viewpoint of the disadvantages as mentioned above, the present inventors have been investigating a method for producing a decorative sintered metallic article and the decorative sintered metallic article, used in jewelry goods, ornaments and clothing accessories or the like. Herein, the decorative sintered metallic article is produced by joining a copper paste containing at least an organic binder, water, and one or more kinds of copper powders selected from a copper powder and a copper alloy powder having a variety of colors including a brown color of copper, a bronze color and a cupronickel color of a copper and nickel alloy, to a silver paste containing at least an organic binder, water, and one or more kinds of silver powders selected from a silver powder and a silver alloy powder. Accordingly, the present invention is finally realized.

Therefore, an object of the present invention is to provide a method for producing a decorative sintered metallic article having a unique pattern created by a sintered copper part produced by firing the copper paste and a sintered silver part produced by firing the silver paste, and the decorative sintered metallic article having the unique pattern.

### Means for Solving the Problems

According to the first aspect of the present invention, a method for producing a decorative sintered metallic article includes the following steps: a [Patterned Piece Producing Step] of alternately arranging a copper paste containing an organic binder, water, and one or more kinds of copper powders selected from a copper powder and a copper alloy powder, the water content being 10 to 35 wt %, and a silver paste containing an organic binder, water, and one or more kinds of silver powders selected from a silver powder and a silver alloy powder, the water content being 10 to 35 wt %.

Then, the step continues forming patterned pastes by at least deforming rows on an upper surface of the alternately arranged copper pastes and silver pastes to draw the pattern, and subsequently drying the patterned pastes, thereby to produce a patterned piece.

After the [Patterned Piece Producing Step] is finished, the method goes forward to a [Decorative Object Shaping Step] of shaping a decorative object by processing the produced patterned piece, and a [Sintered Article Producing Step] of firing the decorative object to obtain a decorative sintered metallic article.

According to the above mentioned method for producing a decorative sintered metallic article, the copper pastes and the silver pastes each of which contains water at a predetermined content are alternately arranged, allowing a pattern such as a Coffee Art pattern or the like to be drawn only by at least deforming the rows on the upper surface of the pastes. Accordingly, this enables an extremely beautiful pattern to be easily drawn compared to a method using the conventional clay-like plastic compound. Hereby, a high level of skill is not required for the above mentioned method. This allows not only a decorative sintered metallic article with a beautiful pattern drawn thereon to be easily produced in a further educational school but also the method to be easily applied to a teaching material at an educational site such as a school.

The above mentioned phrase: “the copper pastes and the silver pastes alternately arranged” should be most broadly interpreted and any restricted interpretation should not be applied thereto. That is, “the copper paste and the silver pastes alternately arranged” includes, for example, a stack constructed by stacking the copper past on at least a part of the plane of the silver paste, and a stack constructed by stacking the silver past on at least a part of the plane of the copper paste (or a shape of the stacking paste is not specified and, for example, a linear shape, a polygonal shape such as a rectangle, a circular shape, and a round shape may be also included). Further, “the copper pastes and the silver pastes alternately arranged” may include an object made by alternately arranging the copper pastes and the silver pastes side by side on the same plane.

The decorative object with a pattern drawn thereon may be fired in the reduction atmosphere or in the oxidation atmosphere. The firing process in the reduction atmosphere requires a complicated work, including the steps of: having the inert atmosphere such as a nitrogen gas continuously flow during the firing step, putting a reduction agent such as charcoal together with the decorative object into a sealed vessel, and heating the resultant mixture from the outside of the vessel. Therefore, preferably, the decorative object is fired in the oxidation atmosphere (or in the air firing). Further, when the decorative object is fired in the oxidation atmosphere, one or more kinds of copper powders selected from a copper powder and a copper alloy powder contained in the copper paste may be preferably restricted to the copper powder with a mean particle diameter of 10 μm or less. Furthermore, after the organic binder has been burned to be removed from the dried paste in the air firing, preferably the silver powder and the copper powder may be further strongly fired in the reduction atmosphere. The above mentioned procedure allows an amount of the oxidation film on the surface of the article formed after firing to be extremely small, resulting in no use of a pickling process.

Note the aforementioned terms “silver alloy” of the present invention mean an alloy of which silver content is 80 wt % or more including, for example, silver of grade 950, grade 925, grade 900 and grade 800 authorized by the Japan quality authorization system. Such a “silver alloy” includes, for example, a silver-Pd alloy of which sulfur resistance is improved. Herein, a silver alloy containing no silver oxide is preferable. The silver alloy containing no silver oxide may prevent a sintered product from being porous.

On the other hand, the aforementioned terms “copper alloy” of the present invention mean an alloy of which copper content is 80 wt % or more including, for example, bronze, gunmetal and cupronickel. Herein, a copper alloy containing no copper oxide is preferable. The copper alloy containing no copper oxide may prevent a sintered product from being porous, similarly to the case of containing no silver oxide in a silver alloy.

Further, according to the present invention, the air firing means that an object is fired in the air, which is construed identical to the firing in the oxidation atmosphere. Moreover, the reduction atmospheric condition includes the atmospheric state inside a sealed vessel in which a reduction agent such as charcoal (that is, a material more easily oxidized than the shaped copper object when heated) is put together with the decorative object after drying (or dried decorative object), and heated from the outside of the vessel. Herein, according to the present invention, the reduction atmosphere is construed identical to the inert atmosphere such as the argon gas atmosphere.

According to the second aspect of the present invention, a method for producing a decorative sintered metallic article comprises the following steps:

a [Copper Paste Producing Step] of mixing water into a composition containing an organic binder and one or more kinds of copper powders selected from a copper powder and a copper alloy powder, such that the water content is adjusted in 10 to 35 wt % of the whole paste, thereby to produce the copper paste; and

a [Silver Paste Producing Step] of mixing water into a composition containing an organic binder and one or more kinds of silver powders selected from a silver powder and a silver alloy powder, such that the water content is adjusted in 10 to 35 wt % of the whole paste, thereby to produce the silver paste.

According to the second aspect of the method for producing the decorative sintered metallic article, the content of water respectively contained in the copper paste and the silver paste may be determined within a specific range. Accordingly, the patterns capable of being drawn become respectively different by changing the water content respectively contained in the copper paste and the silver paste into a desired amount, allowing various patterns to be freely and easily drawn.

According to the third aspect of a method for producing a decorative sintered metallic article, the drying process in the [Patterned Piece Producing Step] is performed by blowing air at room temperature toward a vicinity of the patterned pastes at least at an early stage, so as to facilitate the drying thereof.

Therefore, the third aspect of the method for producing the decorative sintered metallic article may suppress the oxidation of copper, and avoid a large deformation of the product.

Note if air drying is performed from the early stage, the oxidation of copper proceeds, leading to the unfavorable result. Therefore, when the drying of the product is advanced to a certain degree, air drying and heat drying may be conducted.

Heat drying, when the drying of the product is advanced to a certain degree, may be easily conducted by using a drying machine, an electric furnace and a dryer or the like. The heat drying is conducted preferably at a drying temperature of 80 to 120° C. for a drying time of 20 to 40 min.

The drying process in the patterned piece producing step may be completely performed as long as a bending process or the like of the patterned piece is not conducted in the following decorative object shaping step, and the decorative object in the dried state has no obstacle to be shaped. Preferably, the completely dried state at that time means a condition that no steam appears from the dried patterned piece when heated at 80 to 120° C. The dried state may be checked, for example, by making sure whether drops of dew are formed or not when a glass plate or a stainless steel plate is put close to the dried patterned piece heated at 80 to 120° C. If no drops of dew are formed, the drying process may be understood as completed.

Further, air drying may be conducted, after the initial drying has been advanced by facilitating the drying of the object through blowing air at room temperature as mentioned hereinbefore. Note, in such a case, the drying for one or more days may be particularly preferable. The dried state may be checked by heating the object using a dryer or the like, and making sure that no drops of dew are formed on a plate as mentioned hereinbefore.

According to the fourth aspect of a method for producing a decorative sintered metallic article of the present invention, when the temperature in the air firing reaches 350 to 450° C. from room temperature in the [Sintered Article Producing Step], the decorative object is immediately taken out from the heating source. Alternatively, the decorative object is put into the heating source of which temperature is kept at 350 to 450° C. for firing the decorative object in the air. After 5 to 30 min, the decorative object is taken out from the heating source.

Then, the decorative object as mentioned in each procedure is heated from room temperature to 700 to 800° C. for firing in the reduction atmosphere. After that, the firing temperature is kept for 30 min to 9 hr.

According to the fourth aspect of the method for producing the decorative sintered metallic article, the organic binder contained in the dried decorative object is burned out and removed by firing the dried decorative object in the air. After that, the silver powder and the copper powder are further strongly fired in the reduction atmosphere. This procedure allows the amount of the oxidation film on the surface of the decorative object to be extremely small, resulting in no use of a pickling process.

Note a specific method for firing the decorative object in the reduction atmosphere is not particularly limited. However, for example, the decorative object may be fired together with charcoal in a sealed heat-resistant container (such as a stainless steel container or an altaite container), allowing the decorative object to be fired in the reduction atmosphere.

According to the fifth aspect of a method for producing a decorative sintered metallic article, the whole operation of the [Sintered Article Producing Step] is subjected to fire the decorative object in the air, in the above mentioned first and second aspects of the present invention.

According to the fifth aspect of the method for producing the decorative sintered metallic article, the decorative object is fired in the air and is not fired in the reduction atmosphere as used in a conventional method. This enables the following complicated procedures to be avoided. That is, the procedure of having the inert gas such as argon gas and nitrogen gas continuously flow may be avoided, the gas flow being needed for the firing in the reduction atmosphere. Further, the procedure of putting a reduction agent such as charcoal together with the dried object in a sealed vessel and heating the mixture in the vessel from the outside may be also avoided. The above mentioned advantages allow the method for producing a decorative sintered metallic article of the present invention to be more easily utilized in a further education school or the like.

According to the sixth aspect of a method for producing a decorative sintered metallic article, the [Sintered Article Producing Step] is conducted at 660 to 770° C. as a firing temperature and for 3 to 40 min as a firing time.

According to the sixth aspect of the method for producing the decorative sintered metallic article, in particular, the firing process thereof is preferably conducted at a lower temperature and a shorter time than the firing process of a copper shaped object alone or a silver shaped object alone.

Here, the air sintering process may comprise the steps of: preheating an electric furnace up to the firing temperature as described hereinbefore; putting the decorative object into the electric furnace kept at the firing temperature; keeping the firing temperature at the predetermined temperature; and taking out the fired object thereby to be rapidly cooled after the firing time has passed.

According to the seventh aspect of a method for producing a decorative sintered metallic article, one or more kinds of copper powders selected from a copper powder and a copper alloy powder contained in a copper paste are referred to as a mixed copper powder including a first copper powder in 25 to 75 wt %, of which the mean particle diameter is 0.1 to 4.0 μm, and the remainder of a second copper powder of which the mean particle diameter is in the range from more than 4.0 μm to 10 μm or less. Further, one or more kinds of silver powders selected from a silver powder and a silver alloy powder contained in a silver paste are referred to as a mixed silver powder including a first silver powder in 25 to 75 wt %, of which the mean particle diameter is 0.1 to 4.0 μm, and the remainder of a second silver powder of which the mean particle diameter is in the range from more than 4.0 μm to 40 μm or less.

According to the seventh aspect of the method for producing the decorative sintered metallic article, one or more kinds of copper powders selected from a copper powder and a copper alloy powder contained in a copper paste are limited to the copper powders of which the mean particle diameter is 10 μm or less. Together with this, the powders contained in the copper paste and the silver paste are respectively to be specific mixed powders of which the respective mean particle diameters are different. Then, the copper paste and the silver paste are combined to form a decorative object with a pattern, whereby a dried decorative object is produced after the drying process. Accordingly, by conducting the above mentioned procedure, if the resulting dried decorative object is fired in the air at the predetermined firing temperature and time, the decorative object may be fired “without damaging” a shape thereof. Further, a copper paste sintered part (or copper shaped sintered part) and a silver paste sintered part (or silver shaped sintered part) may have a certain degree of strength required for a craft and decorative sintered object.

The above mentioned copper paste and the silver paste are formed by respectively using specific mixed powders of which the respective mean particle diameters are different. This allows a liner contraction rate of each paste to be reduced at the same low level such that one paste does not have a so large contraction rate compared to that of the other paste, which results in causing no pealing or damage in the decorative sintered object.

If a surface of the sintered copper paste is oxidized to form an extremely thin film during the air firing, the inside of the sintered copper paste is hardly influenced by the oxidation. Hereby, the oxidation film on the surface of the sintered copper paste may be easily removed, allowing the appearance of the resulting product to be sufficiently accepted as a decorative sintered metallic article for craft and decoration, which results in the desirable production of the decorative sintered metallic article. Note there is a rare but preferable case that the silver shaped object may be fired in the reduction atmosphere depending on a component of the silver alloy powder contained in the silver paste. However, in general, the silver shaped object may be fired in the air without causing any problems.

Accordingly, no firing in the reduction atmosphere as conducted in conventional techniques enables the following complicated procedures to be avoided. That is, the procedure of having the inert gas such as argon gas and nitrogen gas continuously flow may be avoided, the gas flow being needed for the firing in the reduction atmosphere. Further, the procedure of putting a reduction agent such as charcoal together with the dried object in a sealed vessel and heating the mixture in the vessel from the outside may be also avoided. The above mentioned advantages allow the method for producing a decorative sintered metallic article of the present invention to be more easily utilized in a further education school or the like.

Moreover, in the present invention, the dried decorative objects that have been formed by combining the copper paste and the silver paste are simultaneously (or all at once) fired in the air. This may prevent firing equipment from being used so many times repeatedly, giving the method of the present invention with extremely efficacy.

Here, the terms “mean particle diameter” of the copper powder, the copper alloy powder, the silver powder and the silver alloy powder used in the present invention are also referred to as an average grain diameter, an average particle diameter, a median diameter, a median size, or a 50% particle size; are typically represented as “D50”; and means a particle size corresponding to 50% of a cumulative distribution curve. More specifically, the mean particle diameter is a value of D50 of a particle size distribution obtained by using a laser diffraction-type particle size distribution measurement device with tri-laser scattered light detection mechanism (manufactured by Microtrac Inc.) and setting measurement conditions thereof at “particle permeability: reflection” and “spherical/nonspherical: nonspherical”.

According to the eighth aspect of a method for producing a decorative sintered metallic article, the decorative sintered metallic article is produced by the methods described in the first aspect and the second aspect of the present invention.

Such a decorative sintered metallic article in the eighth aspect appears to have a very clear contrast of colors between the sintered copper paste having a variety of colors including a brown color of copper, a bronze color and a cupronickel color of a copper and nickel alloy, and the sintered silver paste having a silver gray color or the like. Further, the decorative sintered metallic article represents an artistic pattern such as a Coffee Art pattern. Accordingly, the above mentioned characteristics allow the appearance of the decorative sintered metallic article to be sufficiently accepted as a craft and decorative sintered article, used in jewelry goods, ornaments, and clothing accessories or the like.

### Advantageous Effects of the Invention

According to the method for producing the decorative sintered metallic article of the present invention, it comprises the following steps: a patterned piece producing step of alternately arranging a copper paste containing an organic binder, water in 10 to 35 wt % content, and one or more kinds of copper powders selected from a copper powder and a copper alloy powder, and a silver paste containing an organic binder, water in 10 to 35 wt % content, and one or more kinds of silver powders selected from a silver powder and a silver alloy powder.

Then, the step moves on to forming patterned pastes by deforming rows on at least the upper surface of the alternately arranged copper pastes and silver pastes to draw the pattern, and subsequently drying the patterned pastes, thereby to produce a patterned piece.

The next comprises a decorative object shaping step of shaping a decorative object by processing the produced patterned piece, and a sintered article producing step of firing the decorative object which is performed to obtain a decorative sintered object. The above mentioned method of the present invention enables the decorative sintered object with an artistic pattern such as a Coffee Art pattern or the like drawn thereon to be very easily obtained without mastering a high level of any specific technique.

### BRIEF DESCRIPTION OF THE DRAWINGS

FIG. 1 is a diagram schematically showing an example where the copper pastes and the silver pastes are alternately arranged side by side.

FIG. 2 is a diagram schematically showing an example of the pattern drawn when the copper paste and the silver paste are used.

FIG. 3 is a diagram schematically showing an example of the pattern drawn when the copper paste and the silver paste are used.

FIG. 4 is a diagram schematically showing an example of the pattern drawn when the copper and silver pastes changed in the water content thereof are used.

FIG. 5 is a diagram schematically showing an example of the pattern drawn when the copper and silver pastes changed in the water content thereof are used.

FIG. 6 is a diagram schematically showing an example of the pattern drawn when the copper and silver pastes changed in the water content thereof are used.

FIG. 7 is a diagram schematically showing an example of the pattern drawn when the copper and silver pastes changed in the water content thereof are used.

FIG. 8 is a diagram schematically showing a state that the silver containing plastic clay compound is filled as spread in a mold in Example 1.

FIG. 9 is a diagram schematically showing a state where the copper paste is being arranged in a mold into which the silver containing plastic clay compound has been filled, which is performed in Example 1.

FIG. 10 is a diagram schematically showing a temporary state that the copper paste and the silver paste are being alternately arranged in rows in a mold in which the silver containing plastic clay compound has been filled, which is performed in Example 1.

FIG. 11 is a diagram schematically showing a completed state that the copper pastes and the silver pastes are alternately arranged in rows in a mold into which the silver containing plastic clay compound has been filled, which is performed in Example 1.

FIG. 12 is a diagram schematically showing a temporary state that a pattern is being drawn by deforming the rows on the upper surface of the alternately arranged copper pastes and silver pastes by using a needle, which is performed in Example 1.

FIG. 13 is a diagram schematically showing a completed state that a pattern is drawn on the upper surface of the alternately arranged copper pastes and silver pastes, which is performed in Example 1.

FIG. 14 is a diagram schematically showing a patterned piece which has been taken out from the mold after drying the object shown in FIG. 13.

FIG. 15 is a diagram schematically showing a state that the obtained patterned piece is being manipulated to pieces of the desired shapes, which is performed in Example 1.

FIG. 16 is a diagram schematically showing a state that the obtained patterned piece is cut off into pieces of the desired shapes, thereby to form a decorative object, which is performed in Example 1.

FIG. 17 is a diagram schematically showing a state that the obtained decorative object is fired to produce a sintered object, and the sintered object is manipulated to produce a decorative sintered metallic article, which is performed in Example 1.

FIG. 18 is a diagram schematically showing a decorative sintered metallic article produced in Example 2.

### EMBODIMENTS FOR CARRYING OUT THE INVENTION

Firstly, a copper paste and a silver paste of the present invention will be explained.

The copper paste contains an organic binder, water, and one or more kinds of copper powders selected from a copper powder and a copper alloy powder. Such a copper paste is obtained by mixing the above mentioned copper powder, the organic binder and water, to form a paste-like compound. Herein, the water content contained in the copper paste is 10 to 35 wt %, preferably 15 to 30 wt %.

The silver paste contains an organic binder, water, and one or more kinds of silver powders selected from a silver powder and a silver alloy powder. Such a silver paste is obtained by mixing the above mentioned silver powder, the organic binder and water, to form a paste-like compound. Herein, the water content contained in the silver paste is 10 to 35 wt %, preferably 15 to 30 wt %.

The one or more kinds of copper powders selected from a copper powder and a copper alloy powder, preferably used in the present invention, are referred to as a mixed copper powder, including a first copper powder in 25 to 75 wt % with a mean particle diameter thereof in the range from 0.1 to 4.0 μm, and the remainder of a second copper powder with a mean particle diameter thereof in the range from more than 4.0 to 10 μm or less.

Further, the one or more kinds of silver powders selected from a silver powder and a silver alloy powder, preferably used in the present invention, are referred to as a mixed silver powder, including a first silver powder in 25 to 75 wt % with a mean particle diameter thereof in the range from 0.1 to 4.0 μm, and the remainder of a second silver powder with a mean particle diameter thereof in the range from more than 4.0 to 40 μm or less.

As mentioned above, various colors of copper and copper alloys are known, including copper with a brown color, bronze of a copper and tin alloy and cupronickel of a copper and nickel alloy.

Further, silver has a silver gray color, and the silver alloy is used from silver of grade 950, grade 925, grade 900 and grade 800, authorized by the Japan quality authorization system, or a silver-Pd alloy made by adding Pd in 1% to silver.

Herein, a method for producing the above mentioned copper powder, the copper alloy powder, the silver powder, and the silver alloy powder, including the atomization powder and the reduction powder thereof, is not limited specifically. However, a particle with a substantially spherical shape is preferably used.

The decorative object obtained by combining the copper paste and the silver paste each containing the specific mixed powder comprising different mean particle diameters may be fired in the air. Further, the copper shaped sintered part formed by drying and firing the copper paste part, and the silver shaped sintered part formed by drying and firing the silver paste part, may get a certain degree of strength required for use as a craft and/or decorative sintered article. Moreover, contraction rates of the respective sintered objects (or shaped sintered parts) after the firing process are almost the same such that one paste does not have a so large contraction rate compared to that of the other paste, which results in causing no peeling or damage to the decorative sintered object after the firing process.

Further, even though a surface of the copper shaped sintered part is oxidized in an extremely thin layer through the air firing, the inside of the copper shaped sintered part is hardly influenced by the oxidation. Accordingly, the oxidation film on the surface of the copper shaped sintered part is easily removed by rapid cooling, pickling, and polishing treatments, allowing the appearance of the resulting product to be sufficiently accepted as a decorative sintered metallic article for craft and decoration.

Further, one or more kinds of the copper powders selected from a copper powder and a copper alloy powder are referred to as preferably a copper mixed powder, containing the first copper powder in 25 to 75 wt % with a mean particle diameter in the range from 0.5 to 4 μm and the remainder of the second copper powder with a mean particle diameter in the range from more than 4 μm to 10 μm or less. Similarly, the one or more kinds of silver powders selected from a silver powder and a silver alloy powder are referred to as preferably a silver mixed powder, containing the first silver powder in 25 to 75 wt % with a mean particle diameter in the range from 0.5 to 4 μm and the remainder of the second silver powder with a mean particle diameter in the range from more than 4 μm to 30 μm or less.

More preferably, the mixed copper powder contains the first copper powder in 30 to 70 wt % with a mean particle diameter in the range from 2.0 to 3.0 μm and the remainder of the second copper powder with a mean particle diameter in the range from 5 to 10 μm. Similarly, the mixed silver powder contains the first silver powder in 30 to 70 wt % with a mean particle diameter in the range from 2.0 to 3.0 μm and the remainder of the second silver powder with a mean particle diameter in the range from 5 to 20 μm.

The organic binder as described hereinbefore is not limited specifically, however, it may include one or more members selected from the followings: a cellulose-based binder such as methylcellulose, ethylcellulose, hydroxyethylcellulose, hydroxypropylcellulose, hydroxypropylmethylcellulose, and carmellose (carboxymethylcellulose), sodium carboxymethyl cellulose, potassium carboxymethylcellulose, and calcium carboxymethylcellulose; an alginic acid-based binder such as sodium alginate; a polysaccharide-based binder such as starch, dogtooth violet starch, wheat flour, British gum, xanthane gum, dextrin, dextran, and pullulan; an animal-derived binder such as gelatin; a vinyl-based binder such as polyvinyl alcohol and polyvinylpyrrolidone; an acryl-based binder such as polyacrylic acid and polyacrylate ester; and other resin-based binder such as polyethylene oxide, polypropylene oxide, and polyethylene glycol, or the like. If the cellulose-based binder is used, a water-soluble cellulose-based binder is most preferably used.

Further, the following additive may be added to the organic binder where necessary. That is, the additive includes one or more members selected from the following: organic acid (oleic acid, stearic acid, phthalic acid, palmitic acid, sebacic acid, acetylcitric acid, hydroxybenzoic acid, lauric acid, myristic acid, caproic acid, enanthic acid, butyric acid, capric acid, citric acid); organic acid ester such as n-dioctyl phthalate and n-dibutyl phthalate (organic acid ester having a methyl group, ethyl group, propyl group, butyl group, octyl group, hexyl group, dimethyl group, diethyl group, isopropyl group, and isobutyl group); higher alcohol (octanol, nonanol, decanol); polyol (glycerin, arabite, sorbitan, diglycerin, isoprene glycol, 1,3-butylene glycol); ether (dioctyl ether, didecyl ether); lignin which may be cited as a concrete example of the reticular macromolecular substance that results from the condensation of the component unit having phenylpropane as a backbone; liquid paraffin; and oil, or the mixture thereof (for example, olive oil containing rich oleic acid), etc. The additive is added so as to improve plasticity or prevent the copper paste and the silver paste from sticking to a hand during shaping. The lignin and glycerin above-cited as the additive give an appropriate level of a water retention property.

Further, the additive also includes an anionic, cationic, nonionic, or any other surfactant. The surfactant improves miscibility among the silver powder, the copper powder, the organic binder and water, and also improves the water retention property.

Of the organic binders, the water-soluble cellulose-based binder gives plasticity to the copper paste and the silver pastes. The polyethylene oxide gives a high viscosity at a low concentration and increases adhesiveness in its liquid form. The sodium alginate gives an appropriate level of a water retention property, similarly to glycerin and also helps increase adhesiveness. The polyacrylate ester and polyacrylic acid further increase adhesiveness.

As mentioned above, the water-soluble cellulose-based binder gives plasticity to the copper paste and the silver paste. The water-soluble cellulose-based binder includes: methylcellulose, hydroxyethylcellulose, hydroxypropyl-cellulose, hydroxypropylmethylcellulose, sodium carboxy-methylcellulose, potassium carboxymethylcellulose, calcium carboxymethylcellulose, etc, and is used by being dissolved in water.

If the aforementioned water-soluble cellulose-based binder is used as the organic binder, the amount of the organic binder in the copper paste or the silver paste is preferably in the range from 0.1 to 4 wt % by the dry solid content excluding water as the solvent. In this case, if the amount of the organic binder is less than 0.1 wt %, it is difficult to obtain a homogeneous copper paste or a homogeneous silver paste. Further, the strength after application or drying becomes disadvantageously lowered. In contrast, if the amount of the organic binder is more than 4 wt %, the contraction ratio of the obtained object is increased and the object tends to easily crack. Accordingly, the amount of the organic binder is preferably in the range from 0.1 to 4 wt %.

If polyethylene oxide is used, the polyethylene oxide preferably has a molecular weight from a hundred thousand to several millions and is used in the amount in the range from 0.1 to 3 wt %.

Further, if a surfactant is used, the amount thereof is preferably in the range from 0.03 to 3 wt %. If oil is used, the amount thereof is preferably in the range from 0.1 to 3 wt %.

Further, as mentioned hereinbefore, the amount of water contained in the copper paste or the silver paste of the present invention is in the range from 10 to 35 wt %, preferably from 15 to 30 wt %. The water content contained in the respective pastes may be same, or different depending on the necessity.

The amounts of the copper powder and the silver powder respectively contained in the copper paste and the silver paste are not specifically limited, and may be appropriately determined corresponding to the contents of the above mentioned water and organic binder. However, it should be noted that if the contents of the copper powder and the silver powder are too small, the contraction of each paste increases, which results in causing obstruction in the firing process. In contrast, if the contents of the copper powder and the silver powder are too large, hereby the contents of the organic binder and water decrease, which results in causing obstruction in the shaping process.

As a firing accelerator, a powder of Bi, Se, Sb, In, Sn, and Zn or an alloy powder thereof may be added to the copper paste and the silver paste.

Further, as an adhesiveness improver, a glass powder or a metallic compound powder selected from lead carbonate, lithium carbonate, zinc oxide, phosphoric acid, sodium carbonate, vanadium oxide, sodium silicate, phosphate salt, or the like may be added to the pastes.

Further, an organic additive may be added so as to improve the plasticity of the pastes. The organic additive includes lignin which may be cited as a concrete example of the reticular macromolecular substance that results from the condensation of the component unit having phenylpropane as a backbone, glycerin, diglycerin, isoprene glycol, 1,3-butylene glycol, liquid paraffin, alcohols, oil, phthalic acid, n-dioctyl phthalate, n-dibutyl phthalate, and polyvinyl alcohol. Further, a surfactant and a surface-active agent may be also added where necessary.

Moreover, a metal oxide such as zirconium oxide may be added so as to prevent the deformation of the resultant product in the firing process. That is, the addition of a metal oxide allows the firing rate of the paste to be delayed, which results in facilitating a gas diffusion passage to be formed, through which gas generated when the organic binder burns diffuses to the outside of the paste.

Next, a method for producing a decorative sintered metallic article of the present invention, conducted by combining the above mentioned copper paste and silver paste will be explained in detail. The method comprises: a [Patterned Piece Producing Step], a [Decorative Object Shaping Step], and a [Sintered Article Producing Step].

[Patterned Piece Producing Step]

In this step, firstly, the above mentioned copper pastes and the silver pastes are alternately arranged.

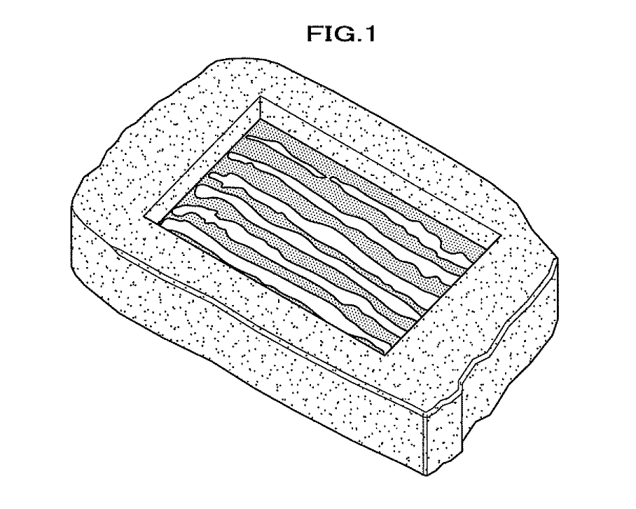

Herein, the above mentioned phrase: “the copper paste and the silver pastes are alternately arranged” should be most broadly interpreted and any restricted interpretation should not be applied thereto. That is, the phrase “the copper pastes and the silver pastes are alternately arranged” may include, for example, a stack that is constructed by stacking the copper paste on at least a part of the plane of the silver paste (herein, a shape of the stacking copper paste is not specified and, for example, a linear shape, a polygonal shape such as a rectangle, a circular shape, and a round shape may be also included). FIG. 1 shows an example that the copper pastes and the silver pastes are alternately arranged in a mold. Inside the mold of FIG. 1, the silver paste is shown as a white color, while the copper paste is shown as a dot pattern.

Further, the silver paste may be stacked on at least a part of the upper surface of the copper paste. Note when one kind of the paste is stacked on at least a part of the surface of the other kind of the paste, the number of the stacked layers is not specifically limited, and may be optionally set as long as the number of the stacked layers does not markedly deteriorate the effect of the present invention.

Further, the copper paste and the silver paste may be alternately arranged side by side on the same plane. In such a case, the arrangement and the shapes of the respective pastes are not specifically limited, and the copper pastes and the silver pastes may be alternately arranged. That is, the copper paste and the silver paste are respectively put into bags or the like and alternately squeezed out from the respective bags. The procedure allows the copper pastes and the silver pastes to be alternately arranged on the same plane. Moreover, by alternately squeezing the copper paste and the silver paste one another so as to create crossing piles, a half-tone dot meshing shape may be formed.

Further, for example, when a ring shaped article such as a ring or the like is produced as a decorative sintered metallic article, the above mentioned copper pastes and the silver pastes may be alternately arranged in a desired pattern on a surface of a base that has been formed beforehand in a ring shape (for example, the base may be formed by a clay-like compound (or a silver containing plastic clay compound) including at least the aforementioned silver powder and the organic binder).

When the copper pastes and the silver pastes are alternately arranged, the pastes may be arranged inside a mold, or the pastes may be arranged without using a mold. Note when each content of water included in the copper paste and the silver paste is large, it may be difficult to control the thickness of each paste without using a mold. Therefore, preferably the copper paste and the silver paste are alternately arranged side by side inside a mold. When a mold is used, a material thereof is not specifically limited. However, a material with elasticity is preferably used. When such a material is used as a mold, a patterned piece (described hereinafter) may be easily taken out from the mold by bending the mold. Such a material includes, for example, silicone or the like. More specifically, for example, “BLUE MIX” (Agsa Japan Co., Ltd.) may be used. Further, the mold may be produced by using the above mentioned silver containing plastic clay compound.

Further, when a mold is used, the shape of the mold is not specifically limited and a mold with a desired shape may be used. Moreover, for example, a “plate” and a “rod shaped member”, which are not called a “mold” strictly, may be used as long as the mold does not markedly deteriorate the effect of the present invention.

Next, is performed a process of deforming at least the rows on the upper surface of the above mentioned alternately arranged copper pastes and the silver pastes. A method for deforming the rows on the upper surface is not specifically limited. For example, a rod-like tool having a pointed shape or a tip portion with a plate shape may be used for the method, including a needle, a bamboo skewer, a toothpick, a wire, a dotting punch, a bodkin, a knife, a lancet, and a spatula or the like. The above mentioned tool may be used to deform at least the rows on the upper surface of the copper pastes and the silver pastes arranged. More specifically, the process comprises the steps of: plunging the tip portion of the tool into the front surface of the pastes toward the bottom thereof, moving the tool to create a desired shape, thereby to draw a pattern. When such a tool is used, the number of the tools is optional, and the moving direction of the tool is not limited.

Alternatively, a pattern may be drawn without using the above mentioned tool. More specifically, for example, when the content of water included in the copper and silver pastes is high, and the copper pastes and the silver pastes are alternately arranged inside a mold, a pattern may be drawn by a breath or a blow of a dryer. A pattern may also be drawn by using a brush for deforming the rows of the pastes. Further, a pattern may be drawn by inclining the mold in which the pastes are arranged, rocking the mold, and vibrating the mold. However, if the mold is inclined too much, the above mentioned rows as well as the arrangement of the copper pastes and the silver pastes may turn to be all deformed. Thus, preferably the mold is inclined at a small angle.

Then, after all, a patterned piece may be formed by drawing the pattern as mentioned above.

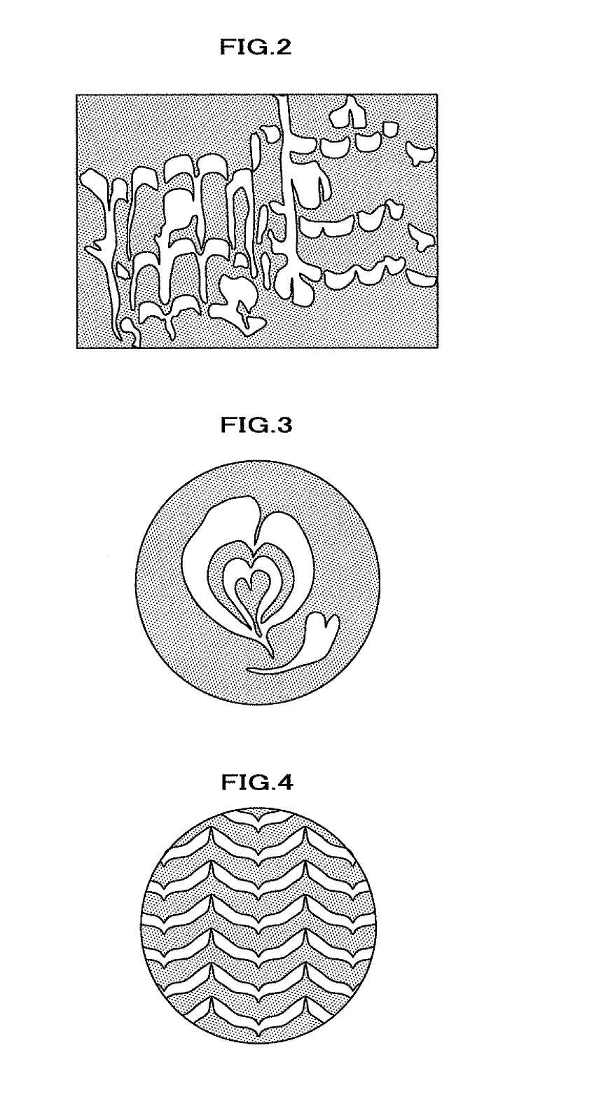

Here, an example of a pattern capable of being shaped will be specifically explained referring to FIGS. 2 to 7, if the pattern is formed by using a needle to the alternately arranged copper pastes and the silver pastes created inside the mold.

FIG. 2 is a schematic diagram showing a pattern formed when five needles are plunged into the rows of the pastes lined up in parallel as vertical to the plane, and moved to the direction crossing the rows of the alternately arranged pastes. Herein, the copper pastes (regions shown as a dot pattern) and the silver pastes (regions shown as a white color) are alternately arranged on the same plane. When the pattern shown in FIG. 2 is formed, at the left half part in the drawing process, the five needles are moved from the front side of the diagram paper toward the rear side direction, while at the right half part the five needles are moved from the rear side of the diagram paper toward the front side direction. As shown in FIG. 2, at the left half of the drawing, the silver pastes are shown as trailing in a lower direction, while at the right half of the drawing, the silver pastes are shown as trailing in an upper direction.

Further, FIG. 3 is a schematic drawing showing a pattern of a stack formed by moving a needle. More specifically, the stack is formed by laying the copper paste inside the whole bottom surface of the mold, and alternately stacking the copper paste and the silver paste so as to form a round shape (or circular shape) on a part of the top surface of the bottom copper paste, and subsequently moving the needle from an upper region of the drawing to a lower region. The resultant pattern indicates that even though those stacked copper pastes and silver pastes formed in a thickness direction are used, a complicatedly shaped pattern may be formed very easily.

Moreover, a pattern capable of being drawn by changing the content of water included in each of the copper paste and the silver paste will be explained referring to FIGS. 4 to 7. FIGS. 4 to 7 are diagrams schematically showing patterns when the copper and silver pastes each of which content of water included therein is changed are used. Table 1 shown below indicates the content of water included in each of the copper paste and the silver paste used in FIGS. 4 to 7.

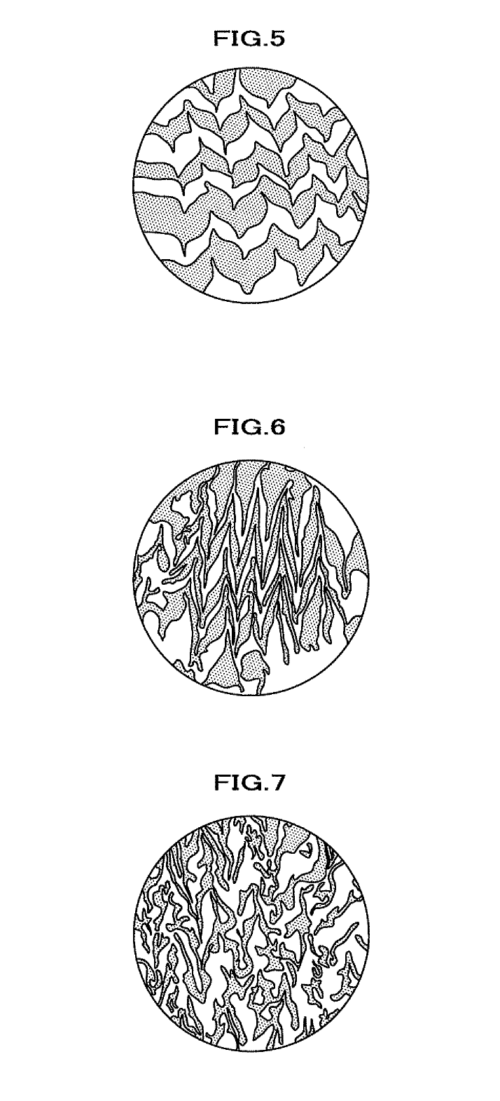

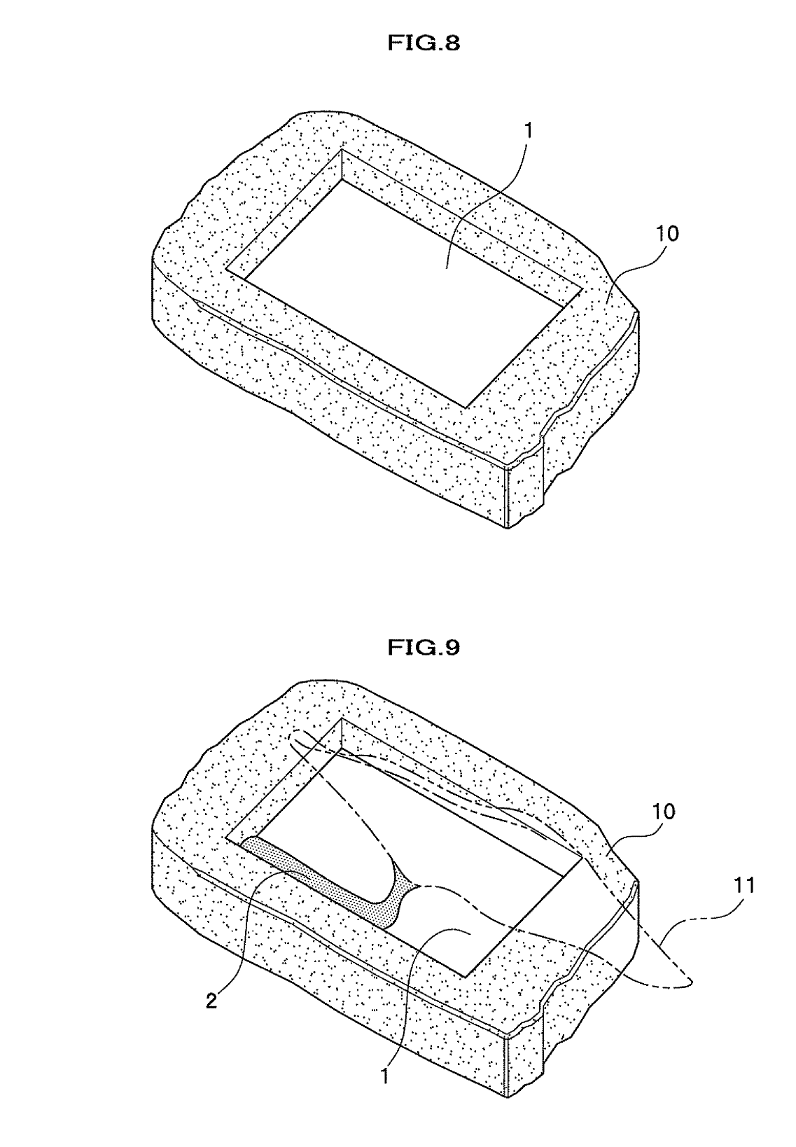

TABLE 1

| | Copper Paste (wt %) | Silver Paste (wt %) |
|---|---|---|
| FIG. 4 | about 23.7 | about 11.4 |
| FIG. 5 | about 18.3 | about 16.3 |
| FIG. 6 | about 23.7 | about 21.9 |
| FIG. 7 | about 29.6 | about 27.9 |

As shown in FIGS. 4 to 7, the more the content of water included in the paste becomes, the more the pattern formed by the copper paste and the silver paste becomes irregular. Accordingly, when a clear pattern is intended to be formed, the content of water may be determined, for example, as the content of water of FIGS. 4 and 5, while an irregular pattern is intended to be formed, the content of water may be determined, for example, as the content of water of FIG. 7.

Here, for example, commercially available products may be used for the copper paste and the silver paste used in the step of the present invention. Herein, a [Copper Paste Producing Step] and a [Silver Paste Producing Step] may be set up, in which the copper paste and the silver paste have been produced beforehand prior to the patterned piece forming step. That is, at least two steps including the copper paste producing step and the silver paste producing step may be set up prior to the patterned piece forming step. More specifically, the copper paste producing step comprises a process of mixing water to a composition containing an organic binder and one or more kinds of copper powders selected from a copper powder and a copper alloy powder such that the water content of the total weight of the resultant composition becomes 10 to 35 wt %. Similarly, the silver paste producing step comprises a process of mixing water to a composition containing an organic binder and one or more kinds of silver powders selected from a silver powder and a silver alloy powder such that the water content of the total weight of the resultant composition becomes 10 to 35 wt %.

Next, the copper pastes and the silver pastes (or patterned pastes) on which a pattern is formed as mentioned hereinbefore are dried, thereby to produce a patterned piece.

A drying method such as a drying procedure and drying conditions is not specifically limited. However, at least at the initial stage of the drying procedure, preferably the patterned pastes are facilitated to be dried by blowing air at room temperature to a vicinity of the patterned pastes. More specifically, for example, when patterned pastes are formed inside a mold, it is preferably to generate airflow by using a dryer or the like in the direction parallel to the surface of the patterned piece. This allows the airflow (or air turbulence) to be generated at the vicinity of the upper surface of the patterned pastes, resulting in the indirect drying of the patterned pastes.

In air drying at the early stage, copper is left in a paste containing much water. This state is not preferable because the oxidation of copper proceeds. Further, the heat drying is not also preferable because deformation of the patterned piece tends to be caused if the heat drying is conducted at the early stage. However, if the paste becomes dried at a certain degree, for example, if the patterned piece becomes capable of being taken out from the mold, the heat drying and the natural drying may be performed.

As mentioned before, when the patterned pastes are facilitated to be dried by blowing air at room temperature to a vicinity of the patterned pastes, and the water content of the copper paste and the silver paste is high, it is not preferable to directly blow air to the patterned pastes because the formed pattern turns to be deformed. In contrast, when the water content of the copper paste and the silver paste is little, air may be directly blown on to the patterned pastes because the formed pattern is not deformed by directly blowing air thereto. Herein, the above mentioned vicinity of the patterned pastes to which air at room temperature is blown to facilitate the drying thereof includes a vicinity to which air is directly blown and a vicinity to which air is not directly blown. Therefore, the terms the “vicinity” may be broadly construed.

In the drying procedure of the patterned piece forming step, if a process of bending the patterned piece or the like is not performed in the decorative object shaping step of the later step and there is no obstacle to shape a decorative object in the dried condition, the patterned piece may be completely dried up.

Further, after the patterned piece becomes dried at a certain degree or the patterned piece becomes able to be taken out from the mold, the patterned piece may be heat-dried at a drying temperature of 80 to 180° C. and for a drying time of 10 to 60 min. If the patterned piece is heat-dried, the heat-drying process thereof may be performed by a drying machine, an electric furnace and a dryer or the like. Herein, the drying temperature is preferably 80 to 120° C. and the drying time is preferably 20 to 40 min.

Here, the completely dried state means that no steam appears from the patterned piece heated at 80 to 120° C. (or dried patterned piece). The completely dried state may be judged by making sure whether drops of dew are formed or not when the dried patterned piece which is heated at, for example, 80 to 120° C. is put close to a glass plate or a stainless steel plate. If no drops of dew are formed on the plate, the drying process may be construed to be completed.

Similarly, after the patterned piece becomes dried at a certain degree or the patterned piece becomes able to be taken out from the mold, natural drying may be performed. In such a case, particularly the natural drying is effective if continued for one day or more. The dried state is checked by heating the patterned piece using a dryer or the like, and making sure that no drops of dew are formed as mentioned above. Further, after the drying process, the dried patterned piece further can be manipulated by a rasp or sandpaper where necessary.

As mentioned hereinbefore, a patterned piece may be produced.

Note at this time, the patterned piece is not necessarily dried completely. For example, when the copper pastes and the silver pastes are arranged inside the mold, the arranged copper and silver pastes (or patterned pastes) may be dried such that the patterned pastes are capable of being taken out from the mold. For example, when the patterned piece is bent to have a ring-like shape in a decorative object shaping step described hereinafter in the later step, the patterned pastes may be dried in such a degree that the patterned pastes are capable of being taken out from the mold.

However, if the patterned piece is not completely dried as mentioned above, preferably a step of completely drying the patterned piece is additionally conducted between the decorative object shaping step described hereinafter and the sintered article producing step.

In the meantime, a ring-like patterned piece may be directly shaped by the processes of: alternately winding the copper paste and the silver paste side by side on a peripheral surface of a wood shaft on which an antiadhesive belt such as a cling film or sticky paper has been wound; deforming rows of the pastes; and drying the patterned pastes. Accordingly, a ring-like patterned piece (or decorative object) may be made in the easy process.

As mentioned above, the method for using the copper paste and the silver paste and alternately arranging the pastes enables a complicated pattern to be easily formed, which has not been achieved by simply using a copper containing plastic clay compound and a silver containing plastic clay compound.

[Decorative Object Shaping Step]

In this step, the patterned piece, which has been obtained in the [Patterned Piece Producing Step], is fabricated to form a decorative object.

A specific method for forming a decorative object from the patterned piece is not particularly limited and various kinds of methods may be used to fabricate the patterned piece. Here, three dimensional shaping may not be necessarily applied, and flat shaping may often be applicable.

The Patent Document 1 discloses that the decorative object shaping step is conducted by only winding a plate to form a cylindrical mixed object, which is not a substantial step to shape a decorative object. In contrast, the decorative object shaping step of the present invention comprises, for example, only cutting off the above mentioned patterned piece into a desired shape, which allows the step to be extremely easily performed without requiring any workload.

Note a specific form of the decorative object is not limited particularly. For example, a ring, a brooch, a pendant and a pair of earrings for pierced ears may be included.

Further, the applied patterned piece may be used as it is (that is, as a plate-like shape) to shape a decorative object. Alternatively, a decorative object may be shaped by using a fabricated piece of which shape is formed by scraping angles at both ends and fabricating the piece such that the vertical cross section thereof to the longitudinal direction has a rounded shape (or the cross section thereof has an arc shape).

Moreover, the four sides of the patterned piece are cut off so as to form a further uniform plate-like shape, and the obtained patterned piece may be used as a decorative object. Furthermore, firstly a plate-like (or belt-like) patterned piece is produced, and then edges of the patterned piece are joined each other to be a ring shape, thereby to shape a decorative object. More specifically, after the patterned piece is taken out from the mold, for example, the patterned piece is softened by using a wet hand towel or the like, and subsequently the patterned piece is wound around on a wood shaft so as to join both edges of the patterned piece, thereby to shape a ring-like decorative object. The procedure may allow a decorative object to be created to which a beautiful pattern is applied.

Further, for example, when the decorative object to be shaped is a ring, preferably a silver plate is arranged inside the ring. That is, when the copper paste and the silver paste are alternately arranged, the silver plate comprised of a silver containing plastic clay compound is used as a base of the ring, and preferably the copper paste and the silver paste are alternately arranged on the silver plate base. Such an arrangement enables the silver plate to be placed inside the ring, which results in preventing the copper from touching to the skin when a finger is inserted into the ring. Further, this arrangement enables the generation of copper rust and verdigris to be prevented, and the strength of the ring itself to be increased.

[Sintered Article Producing Step]

In this step, a decorative object sintered article is obtained by firing the decorative object produced in the

### [Decorative Object Shaping Step].

As mentioned hereinbefore, the decorative object may be fired in the reduction atmosphere or in the air (or oxidation atmosphere).

When the air firing process is conducted, the decorative object is preferably fired at 660 to 770° C. for 3 to 40 min, more preferably at 700 to 750° C. for 10 to 15 min. Accordingly, the decorative object is fired at a lower temperature and for a shorter time than a copper containing plastic clay compound.

In this connection, the air sintering conditions of a shaped object made of only a copper containing plastic clay compound of which included copper powder is pure copper include the following criteria: at 990° C. for 3 to 6 min, at 980° C. for 4 to 15 min, at 970° C. for 5 to 30 min, at 950° C. for 5 to 40 min, at 850° C. for 10 to 50 min, and at 800° C. for 30 to 60 min, preferably at 850 to 980° C., more preferably at 950 to 970° C.

When the decorative object is fired in the air, the method comprises the steps of: preheating an electric furnace to the above mentioned firing temperature, putting the decorative object into the electric furnace kept at the temperature, keeping the predetermined temperature for the above mentioned time, taking out the decorative object from the furnace, and rapidly cooling the decorative object. In this case, the decorative object is not fired in the reduction atmosphere as used in a conventional method. This enables the following complicated procedures to be avoided: having the inert gas such as argon gas and nitrogen gas continuously flow, putting a reduction agent such as charcoal together with the decorative object in a sealed vessel and heating the mixture in the vessel from the outside. The above mentioned advantages allow the method for producing a decorative sintered metallic article to be more easily used in a further education school or the like.

Herein, of course the decorative object may be fired in the reduction atmosphere at the same temperature. However, the higher firing temperature and the shorter firing time may be used preferably.

Further, for example, in the first half step, the decorative object may be fired in the air so as to burn out the organic binder, and in the second half step, the decorative object may be fired in the reduction atmosphere. Such an example includes a method comprising the steps of: immediately taking out the decorative object from a heat source such as an electric furnace when the air firing temperature in the half step reaches 350 to 450° C. from room temperature; or putting the decorative object into a heat source such as an electric furnace of which the inside temperature is kept at 350 to 450° C. thereby to fire the decorative object in the air and taking out the decorative object from the heat source after 5 to 30 min; then putting the decorative object fired in the air together with a reduction agent such as charcoal into a stainless steel vessel; putting the sealed stainless steel vessel into the electric furnace; heating the sealed vessel from room temperature to 700 to 800° C.; and subsequently keeping the temperature for 30 min to 9 hr. The above mentioned half second step allows the decorative object to be fired in the reduction atmosphere.

Note when the decorative object is put into the heat source such as an electric furnace of which inside temperature is kept at 350 to 450° C., the temperature inside the furnace is temporarily decreased. However, an automatic temperature controller such as a thermostat equipped with the electric furnace immediately controls the temperature to be kept at 350 to 450° C.

A case that the decorative object is fired in the argon atmosphere means that the decorative object is fired such that no air is contaminated in the electric furnace by having argon gas flow therein. Therefore, this case is one aspect of the firing in the reduction atmosphere.

[Surface Oxidation Film Removing Step]

The step is not always needed. In the [Sintered Article Producing Step], the decorative object is put into the stainless steel vessel together with a reduction agent such as charcoal, and the decorative object is fired in the reduction atmosphere in the sealed vessel. Then, if the decorative object is cooled as it is in the sealed vessel to room temperature, an oxidation film is not formed, allowing the surface oxidation film removing step to be omitted.

In contrast, if the whole [Sintered Article Producing Step] is conducted by firing the decorative object in the air, it is preferable to conduct the surface oxidation film removing step. In this step, the oxidation film formed on a surface of the decorative sintered object is subjected to rapid cooling, pickling or polishing so as to remove the oxidation film formed on the surface of the decorative sintered object.

The rapid cooling, pickling and polishing are well known methods in a firing technique of this kind of precious metal containing plastic clay compound. The pickling is conducted by immersing the decorative sintered object into an aqueous solution of a pickling solid acid agent (a commercially available product) such as sodium hydrogen sulfate or dilute sulfuric acid for about 5 to 10 min. Then, the resulting object is polished depending on the necessity by a brush, and immediately washed with water. In the polishing process, since a variety of polishing tools such as a polishing spatula, a thread buff, a rotary tool, sandpaper, and a stainless steel brush are commercially available, these tools are appropriately selected and used for polishing.

### EXAMPLES

### Example 1

(Copper Paste Forming Step)

A copper powder composing a copper containing plastic clay compound was made of pure copper. A copper mixed powder was prepared by mixing a first copper powder in 50 wt % (or 45 wt % of the total clay compound) with a mean particle diameter of 2.5 μm, and a second copper powder in 50 wt % (or 45 wt % of the total clay compound) with a mean particle diameter of 10 μm. Then, the mixed copper powder in 90 wt %, methylcellulose as an organic binder in 1.20 wt %, sodium carboxymethylcellulose in 0.30 wt %, and water 8.50 wt % were sufficiently mixed to prepare a clay-like copper containing plastic compound.

Then, the obtained copper containing plastic clay compound (10 g) was put into a plastic bag, and water was added therein such that a final water concentration is adjusted in 18.3 wt %, whereby a paste-like copper paste was produced.

(Silver Paste Forming Step)

A silver containing plastic clay compound comprised of a pure silver powder was made. A silver mixed powder was prepared by mixing a first silver powder in 50 wt % (or 46 wt % of the total clay compound) with a mean particle diameter of 2.5 μm, and a second silver powder in 50 wt % (or 46 wt % of the total clay compound) with a mean particle diameter of 20 μm. Then, the mixed silver powder in 92 wt %, a water soluble binder containing starch as an organic binder in 0.7 wt %, cellulose in 0.8 wt %, and the remainder of water were sufficiently mixed to prepare a clay-like silver containing plastic compound.

Then, the obtained silver containing plastic clay compound (10 g) was put into a plastic bag, and water was added therein such that a final water concentration is adjusted in 16.3 wt %, whereby a paste-like silver paste was produced.

(Patterned Piece Producing Step)

First, a silicone mold was prepared by using “BLUE MIX” (Agsa Japan Co., Ltd.). Then, the silver containing plastic clay compound produced as mentioned above was filled on a bottom of the prepared silicone mold such that a thickness of the plastic clay compound was 1 mm, and water was applied to a surface of the silver containing plastic clay compound by using a paintbrush. This application of water to the surface of the silver containing plastic clay compound allows miscibility between the copper and silver pastes and the silver containing plastic clay compound to be improved, when the silver pastes and the copper pastes are alternately arranged side by side as mentioned hereinafter. Further, this water application may prevent the copper and silver pastes from swallowing up air (or a bubble).

FIG. 8 shows a view schematic showing a state that the silver containing plastic clay compound 1 was filled on a bottom part inside a mold 10.

Next, the copper paste 2 was arranged on the upper surface of the silver containing plastic clay compound 1 by using a bag 11 filled with the copper paste, of which one corner was cut off. The arrangement procedure was shown in FIG. 9.

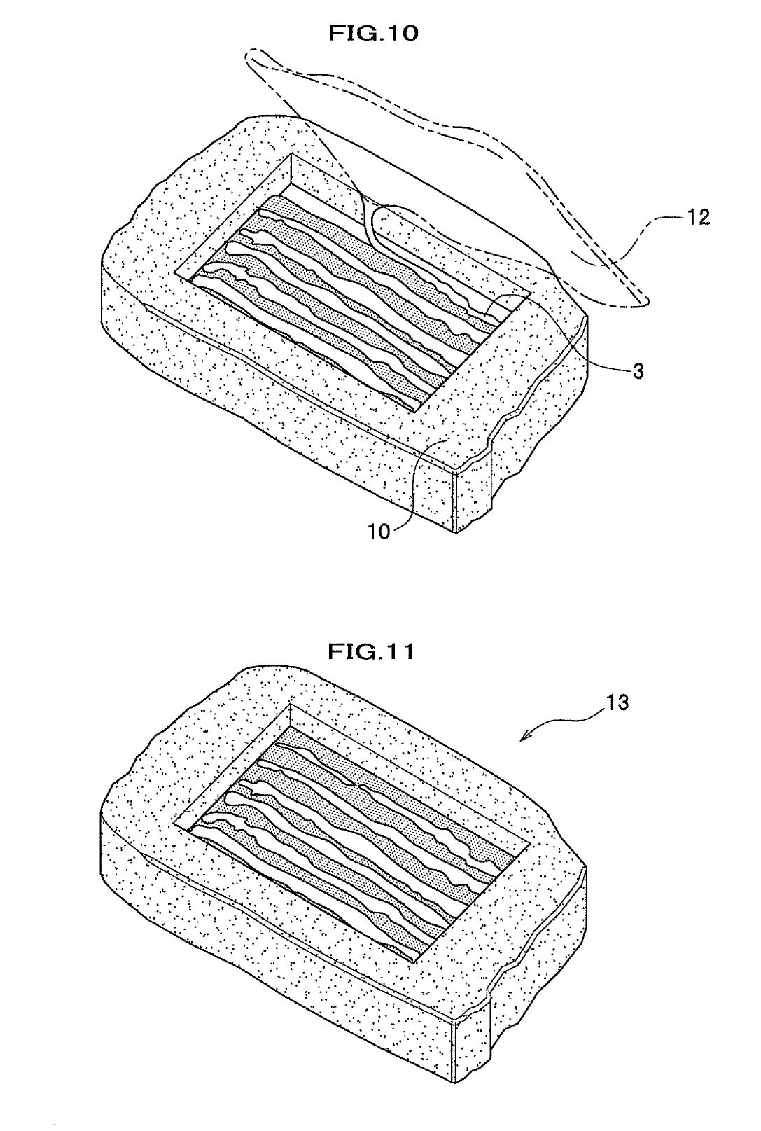

Then, as shown in FIG. 10, the copper pastes 2 and the silver pastes 3 were alternately arranged side by side, using the bag 11 filled with the copper paste, of which one corner was cut off, and a bag 12 filled with the silver paste, of which one corner was also cut off. The arrangement procedure was repeatedly conducted and finally a mold 13 was obtained, in which the copper pastes and the silver pastes were alternately arranged side by side on the base of the silver containing plastic clay compound 1 inside the mold 10. FIG. 11 shows a view of the mold 13.

Then, bubbles present in both pastes were degassed by vibrating the mold 13 in which the copper pastes and the silver pastes were alternately arranged side by side, and further using a vacuum degasser (KATOSANGYO CO., Ltd. (vacuum storage; Type VS)). Note the procedure generated bubbles on the surface of the copper and silver pastes. Hereby, the bubbles were broken by using a wet paintbrush with water.

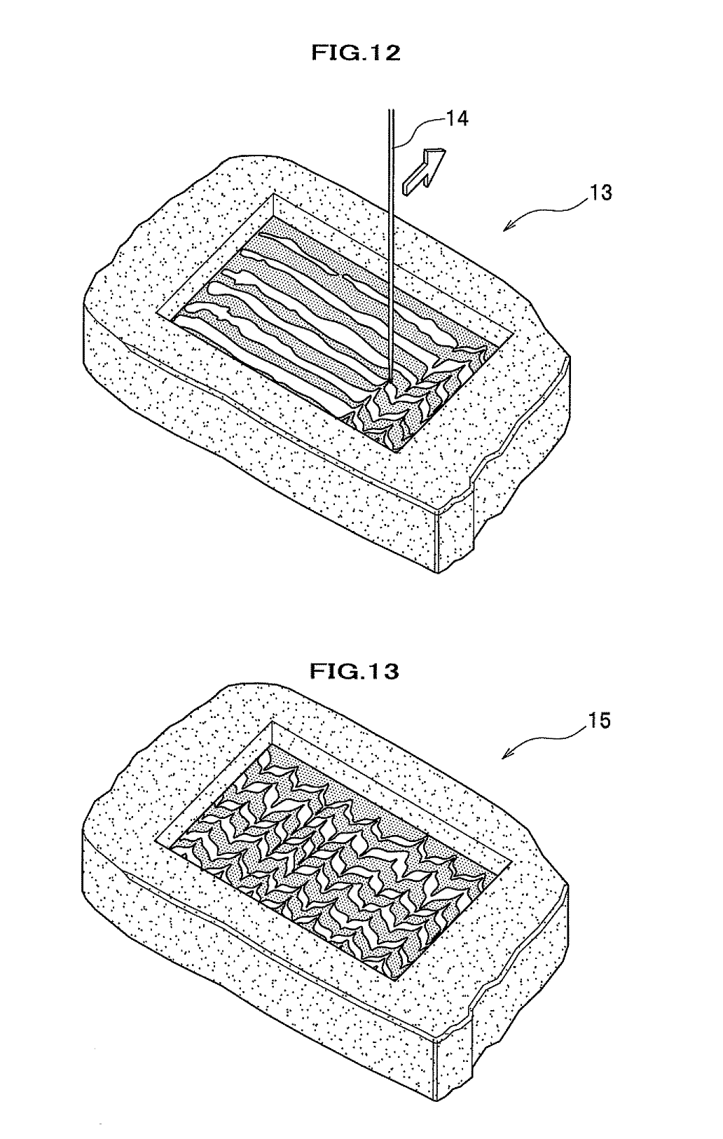

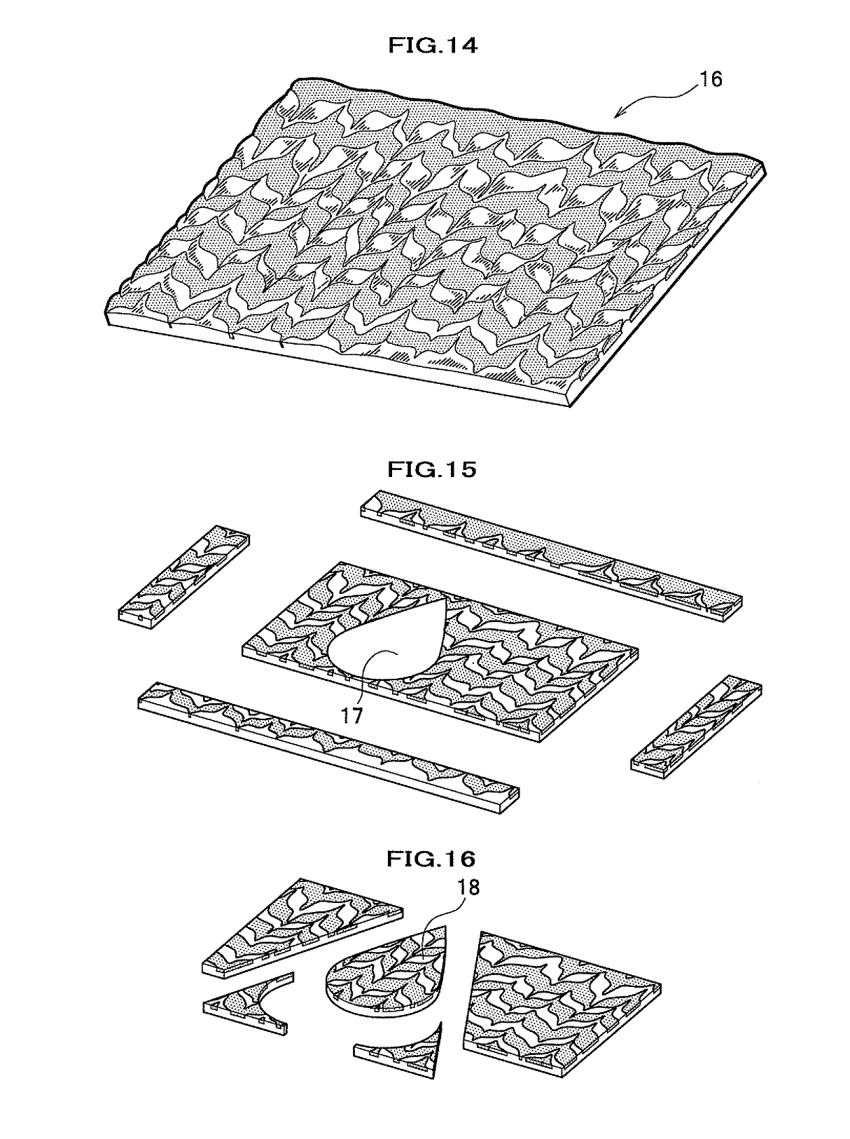

Next, rows on the upper surface of the copper and silver pastes inside the mold 13 were deformed by using a needle 14. The procedure is shown in FIG. 12. Herein, the procedure comprised the processes of: moving the needle 14 in the state pierced to the bottom surface of the mold 13 from one end wall inside the mold 13 to the other end wall; slightly shifting the needle 14 in the direction parallel to the wall; again moving the needle 14 from the other end wall to the one end wall. That is, the needle 14 was moved as going and returning. As mentioned above a pattern was formed by moving the needle 14 through the whole surface of the silver pastes and the copper pastes, formed inside the mold 13 (see FIG. 13). After the procedure, patterned pastes were dried by blowing air at an ambient temperature of a dryer for 3.5 hr, and removed from the mold 15. Then, the patterned pastes were completely dried for 30 min by blowing warm air of a dryer, thereby to produce a patterned piece 16 shown in FIG. 14.

(Decorative Object Shaping Step)

A surface of the patterned piece 16 was rasped by a bar file to flatten the surface thereof. After that, as shown in FIG. 15, marginal parts of the patterned piece 16 were cut off by a knife (OLFA CORPORATION, professional art knife). Then, pattern paper 17 was placed on the upper surface of the patterned piece 16, whereby a shape of the pattern paper 17 was copied on the upper surface of the patterned piece 16.

Along the copied shape of the pattern paper 17, the patterned piece 16 was cut off by an art knife. The cut sections were further reshaped by using the above mentioned bar file. Finally, a chain attachment member was bonded using the silver paste on the upper portion at the rear side of the patterned piece 16, thereby to form a decorative object 18.

(Sintered Article Producing Step)

The decorative object 18 was placed on a board made from fire resistant ceramics fibers (product name: Kaowool Board) and put into an electric furnace so as to be fired in the air. Under the air firing conditions, after the decorative object 18 was put into the electric furnace, the firing temperature was raised to 450° C. from room temperature, and then the decorative object was immediately taken out.

Next, the decorative object 18 fired in the air was embedded in a charcoal bed to a depth of an about 1 cm under the upper surface of charcoal bed which was put in an Altaite vessel, and the Altaite vessel was sealed. Then, the Altaite vessel was put into the electric furnace. When the temperature inside the furnace reached 780° C. from room temperature, the temperature was kept for 8 hours (that is, the firing in the reduction atmosphere). After the decorative object was fired for 8 hours, the Altaite vessel was taken out from the electric furnace, and a decorative sintered object (or decorative sintered metallic article) was immediately taken out from the vessel and cooled.

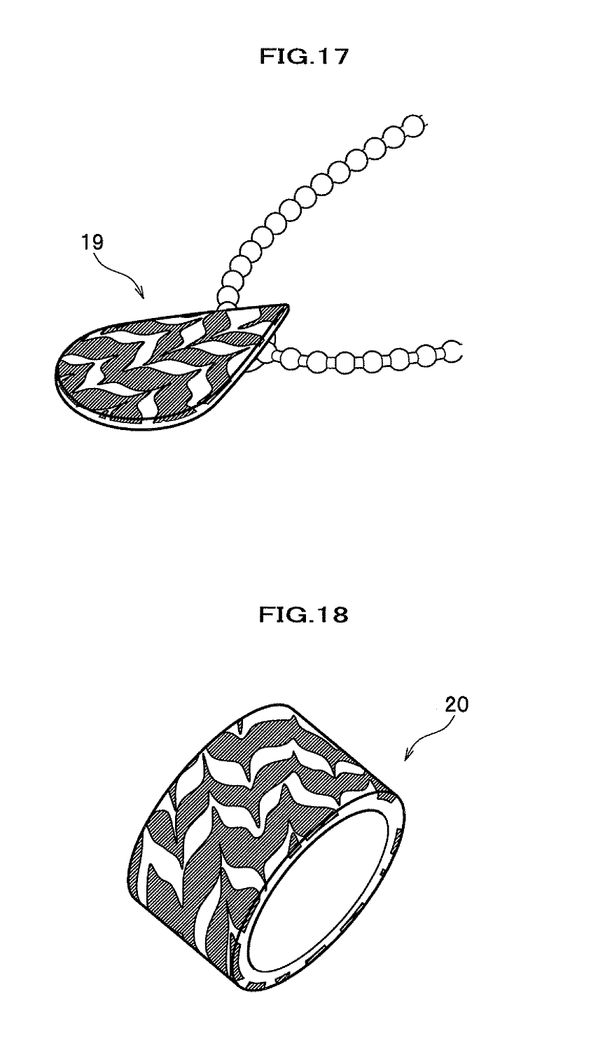

After that, a surface of the decorative sintered object was subjected to pickling and polishing treatments, and a chain was attached thereto, whereby a decorative sintered object (or decorative sintered metallic article) was obtained. The obtained decorative sintered object 19 is shown in FIG. 17. In the pendant-like decorative sintered metallic article 19 (or decorative sintered object) shown in FIG. 17, regions shown as black are made of copper, and regions shown as white are made of silver. As shown in FIG. 17, a clear Coffee Art pattern was formed on the surface of the decorative sintered metallic article 19.

### Example 2

A ring was produced as a decorative sintered metallic article by using the silver containing plastic clay compound, the copper paste and the silver paste, produced in Example 1.

A method for producing the ring comprised the steps of: first extending the silver containing plastic clay compound into a cord shape; further extending the plastic clay compound to have an about 1 mm thickness; and forming a belt-like silver containing plastic clay compound. Then, the silver containing plastic clay compound thus formed was wound around a wood shaft on which sticky paper had been wound, and the wound object was dried. Water was applied to a surface of the silver containing plastic clay compound thus dried, and the above mentioned copper pastes and the silver pastes were alternately arranged side by side on the silver containing plastic clay compound. Then, a pattern was drawn thereon by using a needle as the same method as in Example 1, and the resulting product with a pattern was dried. After drying the product, the dried product was removed from the wood shaft, and subsequently a decorative sintered metallic article was produced as the same method as in Example 1. The decorative sintered metallic article thus produced is shown in FIG. 18. The decorative sintered metallic article 20 shown in FIG. 20 had a silver plate that was arranged at an inner circumference side of a ring shape, and a clear Coffee Art pattern that was formed on an outer circumference surface.

### DESCRIPTION OF REFERENCE CHARACTERS

19 decorative sintered metallic article (or pendant)
20 decorative sintered metallic article (or ring)

1. A method for producing a decorative sintered metallic article, the method comprising the steps of:
producing a patterned piece by,
alternately arranging copper pastes and silver pastes side by side; the copper paste containing an organic binder, water in a content of 10 to 35 wt %, and one or more kinds of copper powders selected from a copper powder and a copper alloy powder, and the silver paste containing an organic binder, water in a content of 10 to 35 wt %, and one or more kinds of silver powders selected from a silver powder and a silver alloy powder;
forming patterned pastes through drawing a pattern by deforming at least rows on an upper surface of the alternately arranged copper pastes and the silver pastes; and
drying the formed patterned pastes to produce a patterned piece;
shaping a decorative object by processing the produced patterned piece; and
obtaining a decorative sintered object by firing the decorative object.

2. The method for producing a decorative sintered metallic article as described in claim 1, the method comprising the steps of:
producing the copper paste by mixing water with a composition containing an organic binder and one or more copper powders selected from a copper powder and a copper alloy powder such that a content of water is adjusted in 10 to 35 wt % of the whole copper paste; and
producing the silver paste by mixing water with a composition containing an organic binder and one or more silver powders selected from a silver powder and a silver alloy powder such that a content of water is adjusted in 10 to 35 wt % of the whole silver paste.

3. The method for producing a decorative sintered metallic article as described in claim 1, the drying process conducted in the patterned piece producing step being facilitated by blowing air to a vicinity of the patterned pastes at least at an early stage of the step.

4. The method for producing a decorative sintered metallic article as described in claim 1, the method comprising the steps of
taking out the decorative object immediately from a heat source when an air firing temperature reaches 350 to 450° C. from room temperature in the sintered object producing step, or putting the decorative object into a heat source of which temperature is kept at 350 to 450° C. thereby to be fired in the air and taking out the decorative object from the heat source after 5 to 30 min,
heating subsequently the decorative object up to 700 to 800° C. from room temperature so as to be fired in a reduction atmosphere, and
keeping the temperature for 30 min to 9 hr.

5. The method for producing a decorative sintered metallic article as described in claim 1, the whole sintered object producing step is conducted by firing in the air.

6. The method for producing a decorative sintered metallic article as described in claim 5, the sintered object producing step is conducted at a firing temperature from 660 to 770° C. and a firing time from 3 to 40 min.

7. The method for producing a decorative sintered metallic article as described in claim 6,
one or more kinds of the copper powders selected from a copper powder and a copper alloy powder, contained in the copper paste, being a mixed copper powder comprising a first copper powder in 25 to 75 wt % with a mean particle diameter from 0.1 to 4.0 μm and a second copper powder of the remainder with a mean particle diameter from more than 4.0 μm to 10 μm or less; and
one or more kinds of the silver powders selected from a silver powder and a silver alloy powder, contained in the silver paste, being a mixed silver powder comprising a first silver powder in 25 to 75 wt % with a mean particle diameter from 0.1 to 4.0 μm and a second silver powder of the remainder with a mean particle diameter from more than 4.0 μm to 40 μm or less.

8. A decorative sintered metallic article produced by the method as described in claim 1.
